(19) United States
(12) Patent Application Publication
(10) Pub. No.: US 2016/0120151 A1
(43) Pub. Date: May 5, 2016

(54) PET TOY

(71) Applicant: TONGFU MANUFACTURING CO., LTD., Nanjing (CN)

(72) Inventors: Wen ZHANG, Nanjing (CN); Huixin YUAN, Nanjing (CN)

(21) Appl. No.: 14/624,972

(22) Filed: Feb. 18, 2015

(30) Foreign Application Priority Data
Oct. 29, 2014 (CN) 201420632577.X

(51) Int. Cl. A01K 11/00

(52) U.S. Cl. CPC A01K 15/026

(57) ABSTRACT

The present utility model relates to a new pet toy, which includes a body, where the body is in an animal shape or a geometric shape, whose surface layer is braided fabric and which is provided with projections available for teeth grinding of a pet, and the body is internally filled with elastic materials. The present utility model has reasonable design, takes various forms, can make a pet grind teeth while satisfying playing of the pet, and also has characteristics such as light weight, rich modeling, and being strong and resistant to bite, which can greatly meet market demands.

### BACKGROUND

1. Technical Field

The present utility model relates to a toy, especially to a toy for pets, and specifically to a new pet toy.

2. Related Art

At present, among pet toys, plush toys account for a greater proportion of the market. However, the plush toys are generally not strong enough, and cannot implement functions such as teeth grinding and resistance to bite. Another type is rubber toys, which are more resistant to bite, but pure rubber toys are generally heavy and are prone to harming humans and objects when thrown, and product appearance and modeling are unitary. Therefore, demands can be better met if a plush toy more resistant to bite can be designed.

### SUMMARY

An objective of the present utility model is to provide a new pet toy with respect to the shortcomings of the prior art, to enable the toy to have better resistant-to-bite ability and meanwhile have characteristics of being lightweight, beautiful and diverse in style.

The technical solution of the present utility model is as follows:

A new pet toy includes a body, where the body is in an animal shape or a geometric shape, whose surface layer is braided fabric and which is provided with projections available for teeth grinding of a pet; and the body is internally filled with elastic materials.

Further, the braided fabric is plush or canvas.

Further, the projections are made of a rubber or plastic material, and are fixed onto the braided fabric through vulcanization, hot melting or injection molding.

Further, the projections are prick-shaped, column-shaped, strip-shaped or recess-shaped, and may also be in other shapes, so as to meet different demands.

The present utility model has the following beneficial effects:

The present utility model has reasonable design, takes various forms, can make a pet grind teeth while satisfying playing of the pet, and also has characteristics such as light weight, rich modeling, and being strong and resistant to bite, which can greatly meet market demands.

### BRIEF DESCRIPTION OF THE DRAWINGS

The disclosure will become more fully understood from the detailed description given herein below for illustration only, and thus are not limitative of the disclosure, and wherein:

FIG. 1 is a schematic diagram of the present utility model.

### DETAILED DESCRIPTION

The present utility model is further described below with reference to the accompanying drawing and an embodiment.

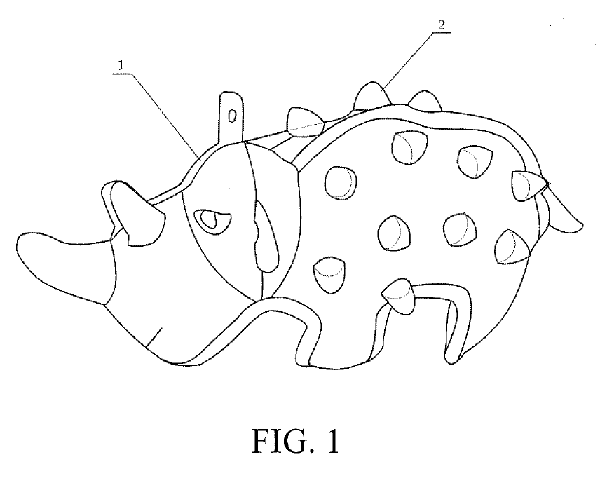

As shown in FIG. 1, FIG. 1 illustrates an embodiment of the present utility model, where a body 1 is included. The body 1 is in a shape of an animal, for example, a rhinoceros, or a geometric shape, for example, a circular ring. A surface layer of the body is braided fabric, such as plush or canvas, and a plurality of projections 2 is disposed on a trunk part of the animal shape. The projections 2 are made of a rubber or plastic material, and are firmly fixed onto the braided fabric through a process such as vulcanization, hot melting or injection molding, so that they are not easy to be avulsed. The projections 2 may be in many shapes, such as prick-shaped, column-shaped, strip-shaped or recess-shaped, so as to meet demands of most pets for grinding teeth or biting. The body 1 is internally filled with elastic materials, such as PP cotton, polyester fibers and foam particles, so that the body 1 has sufficient elasticity and has anticorrosive properties.

Content not involved in the present utility model is the same as that in the prior art or can be implemented with the prior art.

What is claimed is:

1. A new pet toy, comprising a body, wherein the body is in an animal shape or a geometric shape, whose surface layer is braided fabric and which is provided with projections available for teeth grinding of a pet; and the body is internally filled with elastic materials.

2. The new pet toy according to claim 1, wherein the braided fabric is plush or canvas.

3. The new pet toy according to claim 1, wherein the projections are made of a rubber or plastic material, and are fixed onto the braided fabric through vulcanization, hot melting or injection molding.

4. The new pet toy according to claim 1, wherein the projections are prick-shaped, column-shaped, strip-shaped or recess-shaped.
